(19) United States
(12) Patent Application Publication
(10) Pub. No.: US 2011/0128612 A1
(43) Pub. Date: Jun. 2, 2011

(54) WAVELENGTH CONVERSION ELEMENT

(75) Inventors: Chise Namba, Tokyo (JP); Takayuki Yanagisawa, Tokyo (JP); Motoaki Tamaya, Tokyo (JP); Takashi Shirase, Tokyo (JP); Akira Nakamura, Tokyo (JP)

(73) Assignee: Mitsubishi Electric Corporation, Chiyoda-ku (JP)

(21) Appl. No.: 12/952,367

(22) Filed: Nov. 23, 2010

(30) Foreign Application Priority Data
Nov. 30, 2009 (JP) 2009-272466

(51) Int. Cl. G02F 1/35

(52) U.S. Cl. 359/326

(57) ABSTRACT

In a wavelength conversion element in which a periodic poled crystal that converts an input laser light into a laser light of a predetermined wavelength is provided on a thick-film resistance substrate including a heating unit, a heat spreader having a predetermined thermal conductivity, which equalizes a temperature distribution of the periodic poled crystal, is provided between the thick-film resistance substrate and the periodic poled crystal, and the thick-film resistance substrate and the heat spreader, and the heat spreader and the periodic poled crystal are adhered by an adhesive member having a predetermined thermal conductivity.

### BACKGROUND OF THE INVENTION

1. Field of the Invention

The present invention relates to a wavelength conversion element that is equipped with a heating unit and a temperature measuring unit and is to be temperature-controlled.

2. Description of the Related Art

Recently, a technology for using a laser light source in a light source device such as a projector is proposed. The laser light source includes one type that emits a fundamental wave light from a light source directly without converting the wavelength and the other type that converts first the wavelength of the fundamental wave light emitted from the light source by a wavelength conversion element before further emitting. The wavelength conversion element that converts the wavelength of the fundamental wave light includes, for example, a second-harmonic wave generation (SHG) element. The laser light having sufficient light intensity with a desired wavelength can be supplied by using the SHG element and an easily-available general light source.

The SHG element is configured, for example, by forming a periodically domain-inverted structure in which a spontaneous polarization layer and a periodically domain-inverted layer are alternately arranged in parallel repeatedly with a predetermined cycle on a nonlinear optical crystal substrate. This periodically domain-inverted structure is formed in such a manner that a quasi-phase matching is achieved between an incident wave to the nonlinear optical crystal substrate and a second harmonic wave generated by the nonlinear optical effect, enabling thus to obtain high-efficient harmonic light with a stable light intensity. However, in the SHG element, when a refractive-index distribution changes due to the temperature change, the quasi-phase matching condition is violated, so that the efficiency in converting the wavelength is lowered. Therefore, temperature control is performed in the laser light source to maintain the wavelength conversion element such as the SHG element at a predetermined temperature.

For example, a wavelength conversion element is proposed, which has a structure in which a heat diffusion plate that diffuses heat to be conducted to a substrate and an insulating layer on which a wiring pattern is formed on the upper surface thereof are laminated on the upper surface of the substrate having the periodically domain-inverted structure and a heater is arranged on the insulating layer (for example, see Japanese Patent Application Laid-open No. 2009-31539). Moreover, a wavelength conversion element is proposed, which has a structure in which a temperature sensor that detects the temperature of the wavelength conversion element is provided on one main surface of a substrate having the periodically domain-inverted structure and a Peltier element that is substantially as large as the substrate and controls the temperature of the wavelength conversion element is provided on the other main surface opposing the one main surface (for example, see Japanese Patent No. 4285447).

In the wavelength conversion element described in Japanese Patent Application Laid-open No. 2009-31539, the insulating layer is present between the substrate having the periodically domain-inverted structure and the heater. Typically, an insulator has a low thermal conductivity, so that the temperature controllability of the substrate having the periodically domain-inverted structure decreases with the structure described in Japanese Patent Application Laid-open No. 2009-31539 in which the insulating layer is present between the substrate and the heater. Moreover, because the characteristics of the substrate having the periodically domain-inverted structure depend on the temperature, the conversion efficiency may be lowered or the output may become unstable.

Furthermore, in the wavelength conversion element described in Japanese Patent No. 4285447, the Peltier element is provided on substantially the entire surface of one main surface of the substrate having the periodically domain-inverted structure while being in contact therewith, so that the temperature controllability of the substrate is high compared with Japanese Patent Application Laid-open No. 2009-31539. However, when the substrate is directly adhered to the Peltier element, variation in temperature in the surface becomes large, so that the conversion efficiency is lowered and the output becomes unstable.

### SUMMARY OF THE INVENTION

It is an object of the present invention to at least partially solve the problems in the conventional technology, and a wavelength conversion element in which a periodic poled crystal that converts an input laser light into a laser light of a predetermined wavelength is provided on a substrate including a heating unit includes: a heat spreader having a predetermined thermal conductivity, which is provided between the substrate and the periodic poled crystal and equalizes a temperature distribution of the periodic poled crystal, wherein the substrate and the heat spreader, and the heat spreader and the periodic poled crystal are adhered by an adhesive member having a predetermined thermal conductivity.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating an example of a structure of a wavelength conversion element according to a first embodiment of the present invention;

FIG. 2 is a cross-sectional view illustrating an example of the structure of the wavelength conversion element according to the first embodiment;

FIG. 3 is a perspective view illustrating an example of a structure of a wavelength conversion element according to a second embodiment of the present invention;

FIG. 4 is a cross-sectional view illustrating an example of the structure of the wavelength conversion element according to the second embodiment;

FIG. 5 is a perspective view illustrating an example of a structure of a wavelength conversion element according to a third embodiment of the present invention;

FIG. 6 is a cross-sectional view illustrating an example of the structure of the wavelength conversion element according to the third embodiment;

FIG. 7 is a perspective view illustrating an example of a structure of a wavelength conversion element according to a fourth embodiment of the present invention; and

FIG. 8 is a cross-sectional view illustrating an example of the structure of the wavelength conversion element according to the fourth embodiment.

### DETAILED DESCRIPTION OF THE PREFERRED EMBODIMENTS

A wavelength conversion element according to embodiments of the present invention is explained in detail below with reference to the accompanying drawings. The present invention is not limited to these embodiments. Cross-sectional views of the wavelength conversion element used in the following embodiments are schematic, and a relation between the thickness and the width of a layer, a ratio of the thicknesses of the respective layers, and the like are different from realistic ones.

### First Embodiment

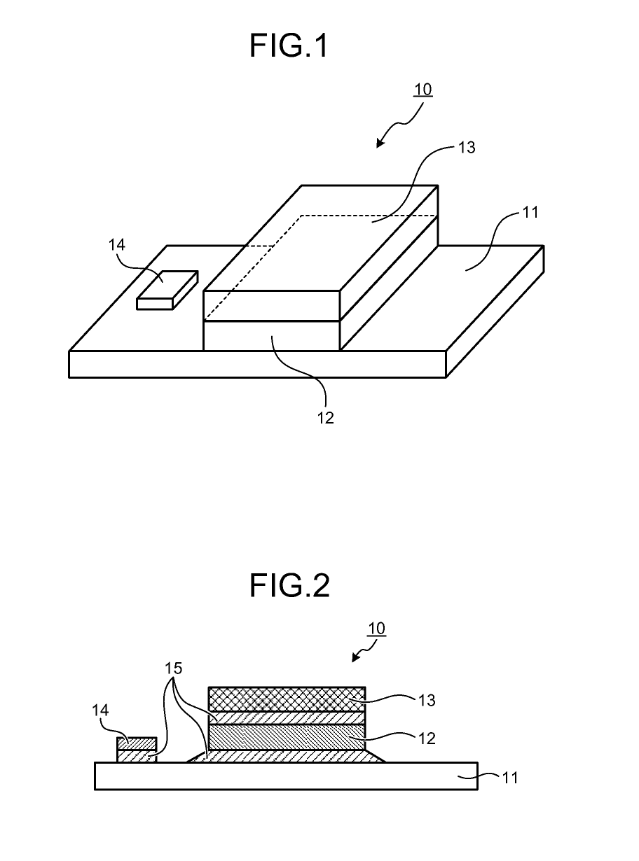

FIG. 1 is a perspective view illustrating an example of a structure of a wavelength conversion element according to the first embodiment of the present invention, and FIG. 2 is a cross-sectional view illustrating an example of the structure of the wavelength conversion element according to the first embodiment. As shown in FIGS. 1 and 2, in a wavelength conversion element 10, a heat spreader 12 is fixed at a predetermined position on one main surface of a thick-film resistance substrate 11 by an adhesive member 15, a periodic poled crystal 13 is further fixed on the heat spreader 12 by the adhesive member 15, and a temperature measuring unit 14 is fixed at a different position on the main surface of the thick-film resistance substrate 11 by the adhesive member 15.

The thick-film resistance substrate 11 consists of a ceramic substrate on which patterns of a resistor and a conductor are printed and fired, and has a function as a heating unit that heats the periodic poled crystal 13. The thick-film resistance substrate 11 can be a substrate including a Peltier element as the heating unit.

The heat spreader 12 has a function of appropriately equalizing the temperature over the entire periodic poled crystal 13. A material having a high thermal conductivity can be used for the heat spreader 12. For example, Cu or Al can be used. The heat spreader 12 consists of a material having a desired thermal conductivity in accordance with the size of the periodic poled crystal 13.

The periodic poled crystal 13 has a function of converting a wavelength of a fundamental wave light from a laser light source (not shown) and emitting it. For example, in the case of the SHG element, one having a periodically domain-inverted structure in which a spontaneous polarization layer with a predetermined width and a periodically domain-inverted layer with a predetermined width are alternately arranged on a lithium niobate substrate as a nonlinear optical crystal can be used.

In the present embodiment, the heat spreader 12 is formed such that the size in an in-substrate-plane direction is almost the same as or slightly larger than that of the periodic poled crystal 13 and the thickness is almost the same as or thinner than that of the periodic poled crystal 13. In this case, the heat spreader 12 has a thickness to have a predetermined thermal conductivity so that the thermal conduction between the periodic poled crystal 13 and the thick-film resistance substrate 11 is efficiently performed.

The temperature measuring unit 14 has a function of measuring the temperature of the thick-film resistance substrate 11 to estimate the temperature of the periodic poled crystal 13, and a thermistor or the like can be used as the temperature measuring unit 14. The temperature measuring unit 14 is arranged on the thick-film resistance substrate 11 at a position that is different from the position on which the periodic poled crystal 13 is mounted but to be close to the periodic poled crystal 13.

Any member can be used as the adhesive member 15 so long as the member has the conductivity and can firmly secure between respective members. For example, a conductive adhesive or a solder can be used as the adhesive member 15. The adhesive member 15 needs to have a thermal conductivity equal to or higher than a predetermined value. The thermal conductivity of the adhesive member 15 is preferably large similarly to the heat spreader 12. Moreover, the adhesive member 15 needs to have a thickness so that a predetermined thermal conductivity can be obtained. Therefore, the adhesive member 15 is preferably as thin as possible. The adhesive member 15 can be nonconductive so long as the adhesive member 15 can have a predetermined thermal conductivity.

When, for example, Cu is used as the heat spreader 12 and the periodic poled crystal 13 has a size of 3-10 mm (optical axis direction)×1-10 mm×0.3-2 mm (thickness), the area of the mounting surface of the heat spreader 12 on which the periodic poled crystal 13 is mounted is substantially the same as or larger than the size of the periodic poled crystal 13, the thickness of the heat spreader 12 is 0.2-0.6 mm, and the size of the thick-film resistance substrate 11 is about 5-20 mm×1-10 mm. For example, in the wavelength conversion element 10 having such a size, if the thickness of the heat spreader 12 is thicker than the above thickness, i.e., 0.6 mm, the thermal conductivity is lowered, which is not preferable. That is, the thickness of the heat spreader 12 is preferably equal to or smaller than 0.6 mm.

In the wavelength conversion element 10 having such a structure, the current to flow in the thick-film resistance substrate 11 is controlled so that the temperature of the periodic poled crystal 13 as a target is adjusted to a target temperature by a control unit (not shown) based on the temperature detected by the temperature measuring unit 14. The resistor generates heat due to the current flowing in the thick-film resistance substrate 11 and the heat uniformly heats the entire periodic poled crystal 13 by the heat spreader 12. In this manner, the temperature of the periodic poled crystal 13 is controlled.

With such a structure, the thermal resistance between the periodic poled crystal 13 and the thick-film resistance substrate 11 as the heating unit is only the heat spreader 12 and the adhesive member 15, so that the thermal response from the thick-film resistance substrate 11 to the periodic poled crystal 13 is accelerated compared with a conventional structure. Moreover, the temperature measured by the temperature measuring unit 14 mounted on the thick-film resistance substrate 11 can be reflected in the temperature of the periodic poled crystal 13 quickly compared with a conventional structure for the similar reason.

The wavelength conversion element 10 of such a structure can be manufactured, for example, in the following manner. First, the periodic poled crystal 13 is fixed on the heat spreader 12 via the adhesive member 15 such as a solder. Thereafter, the heat spreader 12 on which the periodic poled crystal 13 is fixed is fixed at a predetermined position on the thick-film resistance substrate 11 via the adhesive member 15. Moreover, the temperature measuring unit 14 such as a thermistor is fixed at a predetermined position on the thick-film resistance substrate 11 via the adhesive member 15. With the above procedure, the wavelength conversion element 10 having a structure shown in FIGS. 1 and 2 is obtained.

According to the first embodiment, the periodic poled crystal 13 is provided on the thick-film resistance substrate 11 via the heat spreader 12 having a predetermined thermal conductivity and the respective members are adhered to each other by the adhesive member 15 having a predetermined thermal conductivity, so that the thermal resistance between the periodic poled crystal 13 and the thick-film resistance substrate 11 can be made small. Moreover, the temperature distribution in a waveguide is equalized compared with a conventional technology and a stable high output can be obtained. Consequently, the thermal response from the thick-film resistance substrate 11 to the periodic poled crystal 13 is accelerated, so that the periodic poled crystal 13 can be maintained at a predetermined temperature, thus enabling to obtain the wavelength conversion element 10 having high-efficient and stable output characteristics compared with a conventional technology.

### Second Embodiment

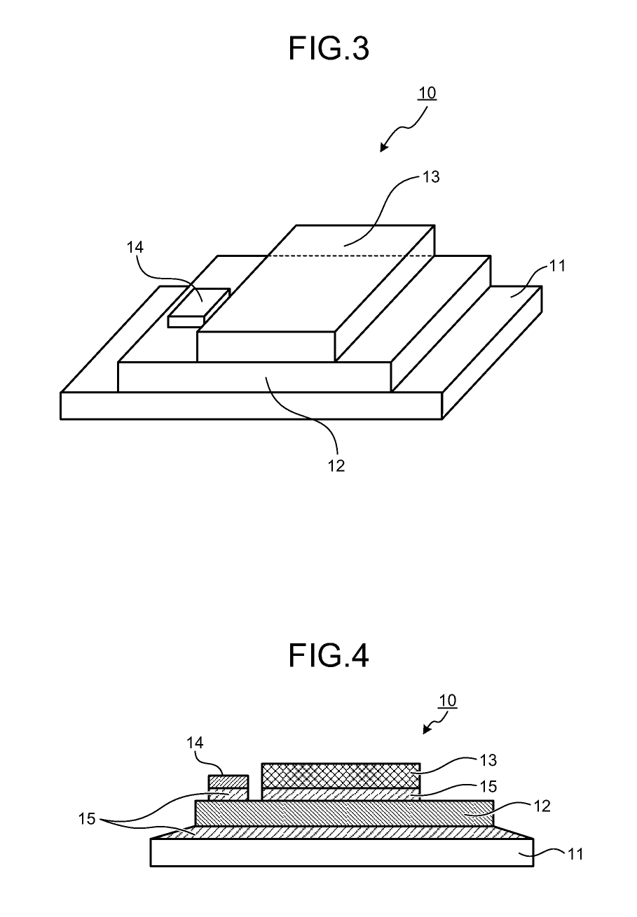

FIG. 3 is a perspective view illustrating an example of a structure of a wavelength conversion element according to the second embodiment of the present invention, and FIG. 4 is a cross-sectional view illustrating an example of the structure of the wavelength conversion element according to the second embodiment. The wavelength conversion element 10 according to the second embodiment is configured such that the size of the heat spreader 12 in a direction parallel to the substrate surface is larger than that of the periodic poled crystal 13 and the temperature measuring unit 14 is fixed on the heat spreader 12 via the adhesive member 15. Components that are the same as those in the first embodiment are given the same reference numerals and explanation thereof is omitted.

According to the second embodiment, the thermal resistance between the periodic poled crystal 13 and the temperature measuring unit 14 is only the heat spreader 12 and the adhesive member 15, so that the temperature measuring unit 14 can measure the temperature that is reflected in the temperature of the periodic poled crystal 13 more correctly and quickly than the case of the first embodiment because the thick-film resistance substrate 11 is not interposed. Consequently, the temperature controllability of the periodic poled crystal 13 can be improved compared with the case of the first embodiment, so that the wavelength conversion element 10 having further stable output characteristics can be obtained.

### Third Embodiment

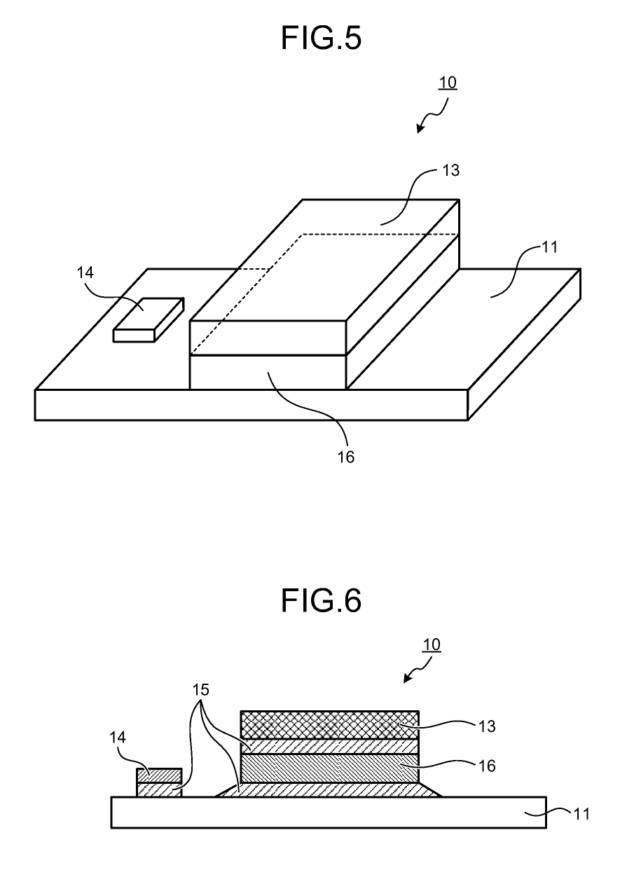

FIG. 5 is a perspective view illustrating an example of a structure of a wavelength conversion element according to the third embodiment of the present invention, and FIG. 6 is a cross-sectional view illustrating an example of the structure of the wavelength conversion element according to the third embodiment. In the wavelength conversion element 10 in the third embodiment, the heat spreader 12 shown in FIGS. 1 and 2 in the first embodiment is replaced by a heat spreader 16 that also has a function as a buffer. Components that are the same as those in the first embodiment are given the same reference numerals and explanation thereof is omitted.

The heat spreader 16 has a function of substantially equalizing the temperature over the entire periodic poled crystal 13 and relaxing stress acting on the periodic poled crystal 13 caused by expansion and contraction due to the temperature change of the thick-film resistance substrate 11 and the periodic poled crystal 13. Specifically, the heat spreader 16 consists of a material having a predetermined linear expansion coefficient or thickness so that the stress due to the difference in width of the expansion and contraction between the thick-film resistance substrate 11 and the periodic poled crystal 13 because of the temperature change is not transmitted to the periodic poled crystal 13. For example, a material having a linear expansion coefficient close to that of the periodic poled crystal 13 can be used as a material for the heat spreader 16. The heat spreader 16 preferably has a thickness to such a degree that the stress due to the difference in width of the expansion and contraction between the thick-film resistance substrate 11 and the periodic poled crystal 13 is not transmitted to the periodic poled crystal 13. The heat spreader 16 can have a linear expansion coefficient between those of the thick-film resistance substrate 11 and the periodic poled crystal 13. When the linear expansion coefficient of the thick-film resistance substrate 11 is large, the linear expansion coefficient of the heat spreader 16 can be made smaller than that of the periodic poled crystal 13 so that an apparent linear expansion coefficient of the heat spreader 16 considering the influence of the thick-film resistance substrate 11 is close to the periodic poled crystal 13. The thickness of the heat spreader 16 is determined in advance by calculation based on a material or a thickness of the thick-film resistance substrate 11, the heat spreader 16, and the periodic poled crystal 13 to be used. In this case, the thickness of the heat spreader 16 is set to the degree that the thermal resistance becomes a predetermined value required for controlling the periodic poled crystal 13 and the stress is not transmitted to the periodic poled crystal 13.

For example, when Cu is used as the heat spreader 16 and the periodic poled crystal 13 has a size of 3-10 mm (optical axis direction)×1-10 mm×0.3-2 mm (thickness), the area of the mounting surface of the heat spreader 16 on which the periodic poled crystal 13 is mounted is substantially the same as or larger than the size of the periodic poled crystal 13, the thickness of the heat spreader 16 is 0.2-0.6 mm, and the size of the thick-film resistance substrate 11 is about 5-20 mm×1-10 mm. For example, in the wavelength conversion element 10 having such a size, if the thickness of the heat spreader 16 is thicker than the above thickness, i.e., 0.6 mm, the thermal conductivity is lowered, which is not preferable. That is, the thickness of the heat spreader 16 is preferably equal to or smaller than 0.6 mm. Moreover, if the thickness of the heat spreader 16 is thinner than the above thickness, i.e., 0.2 mm, for example, the stress between the thick-film resistance substrate 11 and the periodic poled crystal 13 due to the difference in width of the expansion and contraction between the thick-film resistance substrate 11 and the periodic poled crystal 13 because of the temperature change is transmitted to the periodic poled crystal 13, so that the heat spreader 16 does not function as a buffer. That is, the thickness of the heat spreader 16 is preferably equal to or larger than 0.2 mm.

Accordingly, in the third embodiment, the heat from the thick-film resistance substrate 11 is efficiently transmitted to the periodic poled crystal 13, and the stress that the periodic poled crystal 13 receives from the thick-film resistance substrate 11 due to the temperature change because of the difference in the linear expansion coefficient is suppressed by the specification (linear expansion coefficient and thickness) of the heat spreader 16, thereby preventing the periodic poled crystal 13 from being damaged.

According to the third embodiment, the heat spreader 16 has a function as a buffer for preventing the stress due to the difference in width of the expansion and contraction because of the temperature change between the thick-film resistance substrate 11 and the periodic poled crystal 13 from being transmitted to the periodic poled crystal 13, so that the effect of suppressing occurrence of damage such as a crack of the periodic poled crystal 13 due to the stress as a result of the long term use can be obtained in addition to the effect in the first embodiment. Moreover, a stable high output can be obtained by suppressing the temperature distribution.

### Fourth Embodiment

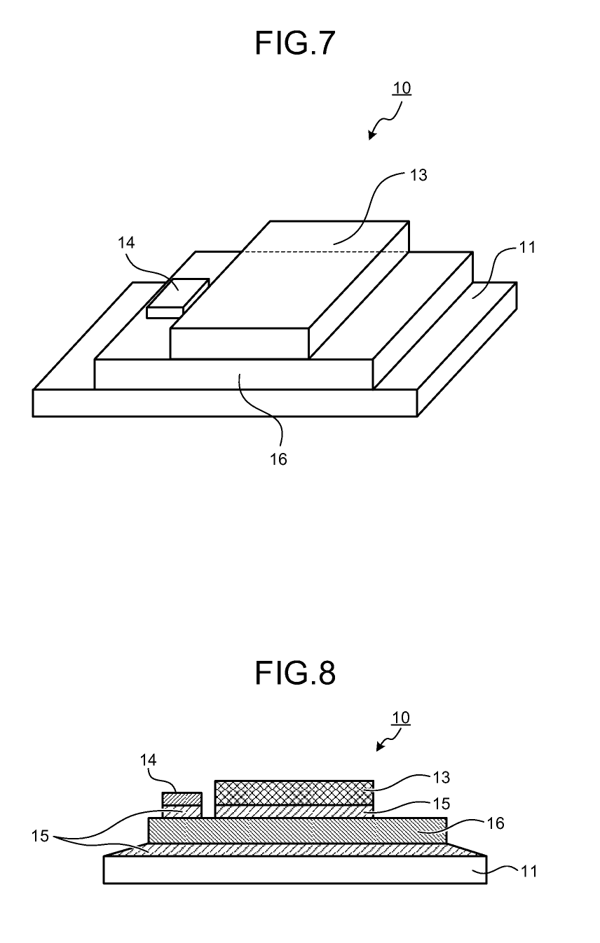

FIG. 7 is a perspective view illustrating an example of a structure of a wavelength conversion element according to the fourth embodiment of the present invention, and FIG. 8 is a cross-sectional view illustrating an example of the structure of the wavelength conversion element according to the fourth embodiment. The wavelength conversion element 10 according to the fourth embodiment is configured such that the size of the heat spreader 16 in a direction parallel to the substrate surface is larger than that of the periodic poled crystal 13 and the temperature measuring unit 14 is fixed on the heat spreader 16 via the adhesive member 15 different from the third embodiment. Components that are the same as those in the first and third embodiments are given the same reference numerals and explanation thereof is omitted.

According to the fourth embodiment, the thermal resistance between the periodic poled crystal 13 and the temperature measuring unit 14 is only the heat spreader 16 and the adhesive member 15, so that the temperature measuring unit 14 can measure the temperature that is reflected in the temperature of the periodic poled crystal 13 more correctly and quickly than the case of the third embodiment because the thick-film resistance substrate 11 is not interposed. Consequently, the temperature controllability of the periodic poled crystal 13 can be improved compared with the case of the third embodiment, so that the wavelength conversion element 10 having further stable output characteristics can be obtained.

According to an aspect of the present invention, a thermal response is accelerated and a periodic poled crystal is maintained to a predetermined temperature, so that a laser light with high-efficient and stable output characteristics compared with a conventional technology can be obtained.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wavelength conversion element in which a periodic poled crystal that converts an input laser light into a laser light of a predetermined wavelength is provided on a substrate including a heating unit, the wavelength conversion element comprising
a heat spreader having a predetermined thermal conductivity, which is provided between the substrate and the periodic poled crystal and equalizes a temperature distribution of the periodic poled crystal, wherein
the substrate and the heat spreader, and the heat spreader and the periodic poled crystal are adhered by an adhesive member having a predetermined thermal conductivity.

2. The wavelength conversion element according to claim 1, wherein the heat spreader further has a function of relaxing a stress exerted on the periodic poled crystal.

3. The wavelength conversion element according to claim 2, wherein
the heat spreader has a linear expansion coefficient in accordance with a material used for the substrate and the periodic poled crystal, and
a thickness of the heat spreader is set to a thickness so that the stress exerted on the periodic poled crystal is relaxed.

4. The wavelength conversion element according to claim 1, wherein
a size of the heat spreader in a substrate surface is substantially equal to the periodic poled crystal, and
the wavelength conversion element further includes a temperature measuring unit that is adhered to the substrate by the adhesive member.

5. The wavelength conversion element according to claim 1, wherein
a size of the heat spreader in a substrate surface is larger than the periodic poled crystal, and
the wavelength conversion element further includes a temperature measuring unit that is adhered to the heat spreader by the adhesive member.
